(19) United States
(12) Patent Application Publication
(10) Pub. No.: US 2019/0135060 A1
(43) Pub. Date: May 9, 2019

(54) Vehicle Lift Tow System

(71) Applicant: W. Paul Frisz, Orlando, FL (US)

(72) Inventor: W. Paul Frisz, Orlando, FL (US)

(21) Appl. No.: 15/807,036

(22) Filed: Nov. 8, 2017

(51) Int. Cl. B60D 1/46; B60D 1/18; B60D 1/14; B60D 1/155; B60P 3/07; B60D 1/24

(52) U.S. Cl. CPC B60D 1/465; B60D 1/187; B60D 1/246; B60D 1/155; B60P 3/07; B60D 1/143

(57) ABSTRACT

A tow system tows a vehicle behind another vehicle, typically a motor coach or RV. A drive support unit is connected to the hitch insert and includes a fixed vertical shaft. A movable lift support moves a sliding support post between an up position and a down position parallel to a fixed vertical shaft. A vehicle coupler for selectively connects and disconnects the movable lift support assembly to the secondary vehicle while in the down position, and the vehicle coupler raises the first end of the secondary vehicle when moved to the up position for towing the secondary vehicle behind the primary vehicle. A pivot arm pivots about the sliding support post to further elevate a pintle, which receives a lunette ring therein. The lunette ring extends out of a tow bar, which is secured to the underside of the vehicle being towed.

### BACKGROUND ART

### 1. Field of the Invention

The invention relates to tow systems for towing one vehicle behind another vehicle, such as towing a passenger automobile behind a motorhome or RV. More particularly, the invention relates to tow systems that easily connect to and tow larger vehicles behind a motorhome or RV.

### 2. Description of the Related Art

Due to the size of many motor homes, people elect to tow a smaller automobile or other vehicle behind their motor home such that upon arrival and parking of the motor home, the other vehicle may be unhitched and used while the motor home remains parked. There have been various solutions for towing a secondary vehicle behind a primary vehicle, such as in the case of a motorhome. Many of the solutions are either complex to connect, cumbersome due to size, or difficulty in use when driving.

One solution includes using a tow bar which connects the secondary vehicle to the primary vehicle. The tow bar pulls secondary vehicles while all four wheels remain engaged with the ground. The tow bar typically consists of two elements: the tow bar or wishbone portion that attaches to a trailer hitch, and the base plate which attaches to the chassis of the towed vehicle. Driving can be difficult for the driver and hard on the towed vehicle when the towed vehicle remains on all four wheels.

A second solution includes use of a tow dolly. The tow dolly is a short, two-wheeled trailer that transports the secondary vehicle with two of its wheels off the ground. The dolly is first coupled to the motorhome, then the towed vehicle is driven up ramps on the dolly so that the two drive wheels rest on the dolly and the other two wheels of the vehicle are on the ground. Problems with the tow dollies include the motorhome owner must find a place for the dolly when parked, and most states require licensing of dollies and trailers.

A third solution includes use of a trailer wherein a secondary vehicle is towed with all four wheels off the ground and supported by the trailer. A trailer can be costly, and the trailer would be typically removed requiring storage while not in use. Furthermore, a trailer adds weight so that the total combined weight may be more than the towing capacity of the average motor home.

There are also know mechanical and motorized lifts for cargo, which are connected to a trailer hitch. Such lifts are typically direct connected worm drives to load arms for lifting light weight loads, such as in U.S. Pat. No. 7,798,760 issued Sep. 21, 2010.

### SUMMARY OF THE INVENTION

A lift tow system is compact and can raise the front wheels of a towed vehicle off the ground for simplified portability, use and storage. The lift tow system is for connection to a primary vehicle having a trailer hitch receiver to tow a secondary vehicle having first and second vehicle ends and an undercarriage frame. The system includes a hitch insert for support within the trailer hitch receiver. A drive support unit is connected to the hitch insert. A movable lift support assembly is movably connected to the drive support unit for moving between an up position and a down position with respect to the hitch insert. A vehicle coupler connects and disconnects the secondary vehicle to the movable lift support assembly in the down position and the vehicle coupler raises the first end of the secondary vehicle when connected to the primary vehicle as the movable lift support assembly moves to the up position for towing the secondary vehicle behind the primary vehicle.

The invention also includes the vehicle coupler including a pintle and a frame mount securely attached to the undercarriage frame of the secondary vehicle. The frame mount includes a coupling arm extending from the secondary vehicle. The vehicle coupler includes a removable tow bar for removable connection to the pintle and to the coupling arm so that the secondary vehicle can be disconnected from the primary vehicle when not being towed by removal of the tow bar between the pintle and the coupling arm.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 shows a perspective view of the tow system in a lifted and stored position;

FIG. 2 shows a side, perspective view of the tow system in the lowered position;

FIG. 3 shows a perspective view of the tow system in a loaded and raised towing position;

FIG. 4 shows a side view of the tow system;

FIG. 5 shows a cut away end view of the hitch support arm;

FIG. 6 shows a cross-sectional view taken along lines 6-6 of FIG. 4;

FIG. 7 shows an end view of the pivot support member

FIG. 8 shows an end view of the pivot arm; and

FIG. 9 shows a perspective view of the tow bar of the tow system connected to a vehicle.

### DETAILED DESCRIPTION OF THE DRAWINGS

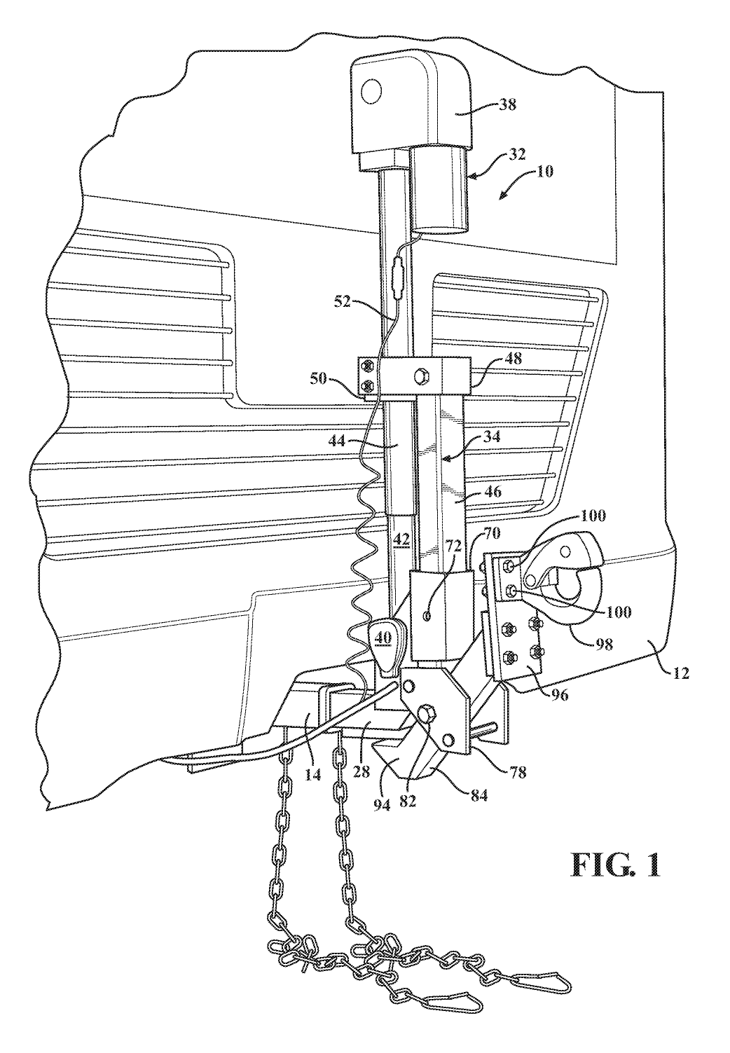

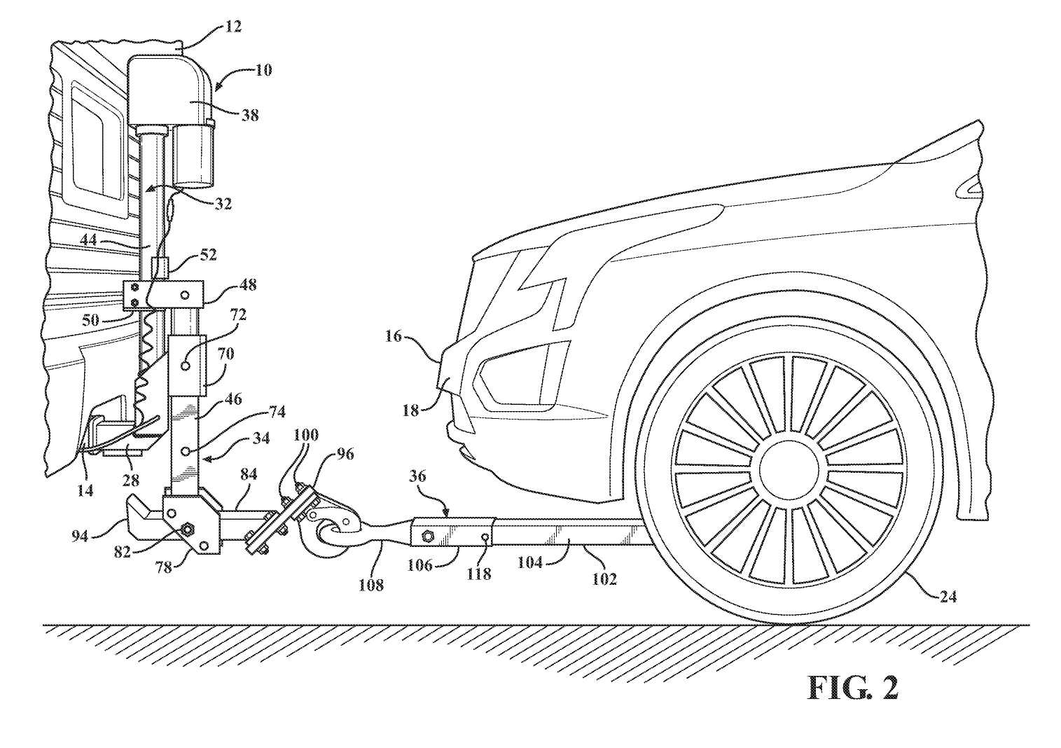

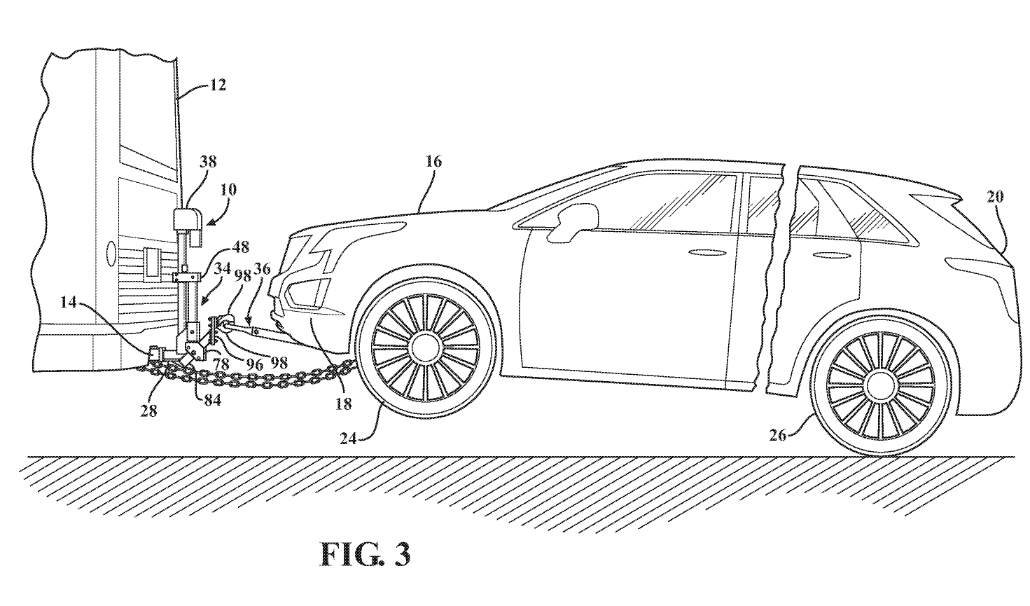

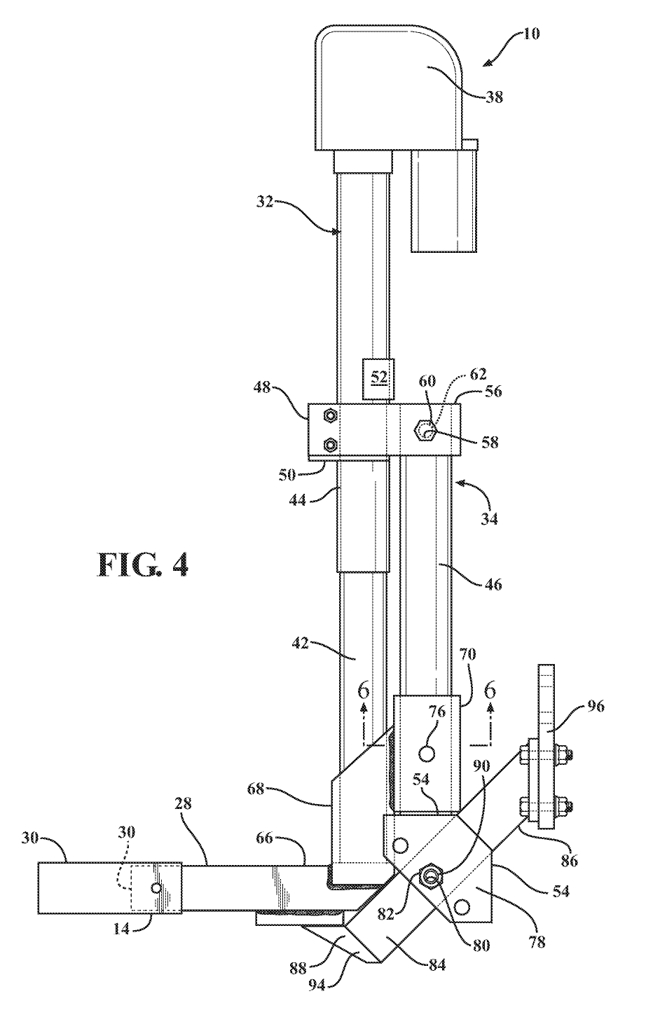

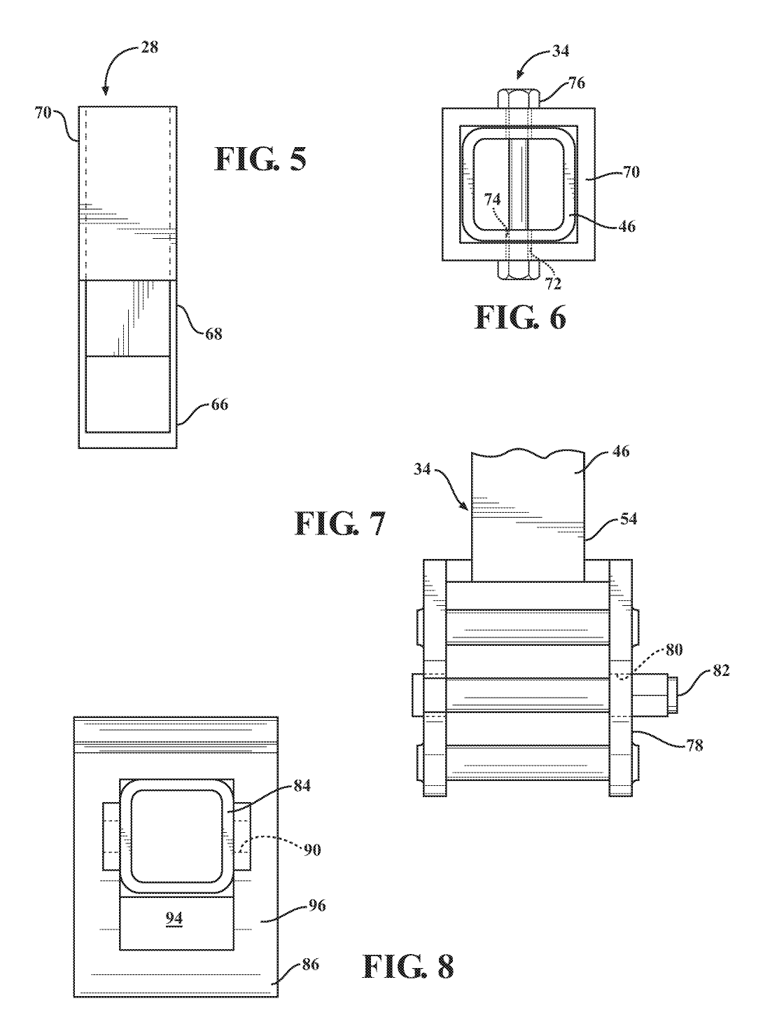

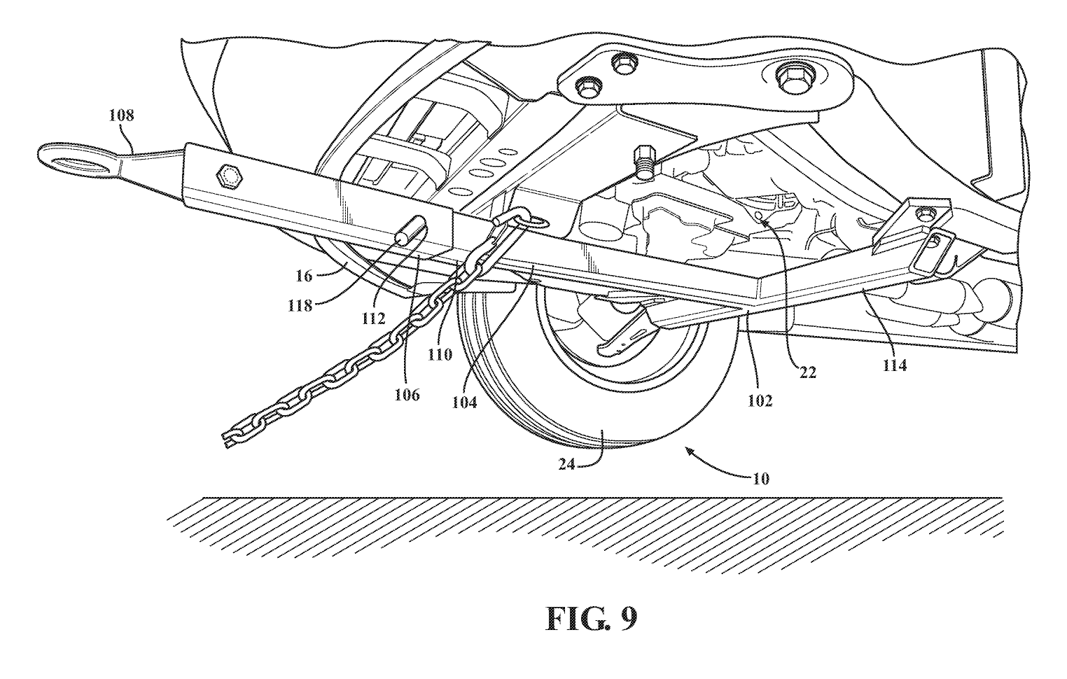

A tow system 10 for connection to a primary vehicle 12 is shown in FIGS. 1-3. The primary vehicle 12 may be a motorhome or RV, or other type of vehicle capable of towing. The primary vehicle 12 includes a standard trailer hitch receiver 14, which is capable of coupling to and supporting the tow system 10. The tow system 10 is used to tow a secondary vehicle 16, such as illustrated in FIGS. 2 and 3. The secondary vehicle 16 is shown having first 18 and second 20 vehicle ends with an undercarriage frame 22, as commonly known in the art. The first vehicle end 18 typically provides a front set of wheels 24 and the second vehicle end 20 provides a rear set of wheels 26. The description refers to the first vehicle end 18 as being the front wheels 24 and the second vehicle end 20 being the rear wheels 26; however, it is within the invention to tow the secondary vehicle 16 at either end 18, 20 or by either set of wheels 24, 26. Also, it is to be appreciated in the art that any type of secondary vehicle 16 may be used with the tow system 10 and it is not limited to a vehicle having four wheels. Further, the tow system 10 may tow the secondary vehicle 16 by lifting the front set of wheels 24 off the ground as is shown in the Figures, or it may leave all of the wheels 24, 26 on the ground while towing.

The tow system 10 includes a hitch support arm 28 having a hitch insert 30 for coupling to and being supported within the trailer hitch receiver 14 of the primary vehicle 12. This allows the tow system 10 to be removed as desired from the primary vehicle 12. It also allows the tow system 10 to be used on any primary vehicle 12 having a suitably load-rated trailer hitch receiver 14 without custom modification to the primary vehicle 12.

The tow system 10 includes an upright or vertical drive support unit 32 connected to the hitch support arm 28 and a movable lift support assembly 34 movably connected to the drive support unit 32 for moving between an up position and a down position with respect to the drive support unit 32, the hitch insert 30 and hitch support arm 28. The movable lift support assembly 34 includes a vehicle coupler 36 for connecting and disconnecting the secondary vehicle 16 so that the vehicle coupler 36 can be attached to the secondary vehicle 16 in the down position while the front wheels 24 of the secondary vehicle 16 rest on the ground. The vehicle coupler 36 lifts the front wheels 24 of the secondary vehicle 16 are raised and is supported by the vehicle coupler 36 as the movable lift support assembly 34 moves to the up position so that only the rear wheels 26 rest on the ground. With certain type of vehicles, the secondary vehicle 16 may be rotated so that the rear wheels 26 are lifted with the front wheels 24 on the ground.

The drive support unit 32 includes an electro-mechanical drive system 38 for moving the lift support assembly 34 between the up and down positions. Such drive system 38 may be in the form of a motorized worm gear, a hydraulic pump device, or any other drive systems as commonly known in the art. In the preferred embodiment, the drive system 38 is operated by a wired controller 40, as shown, though a wireless controller is also contemplated. The drive system 38 may also be solely mechanically driven as commonly known in the art.

The drive support unit 32 includes a fixed vertical, first inner shaft 42 fixedly connected to the hitch support arm 28 and a second outer shaft 44 sliding with respect to the inner shaft 42. The drive system 38 is attached between the first shaft 42 and second shaft 44 to extend and retract the first shaft 42 with respect to the second shaft 44 causing the tow system 10 to move between the up and down positions. The drive support unit 32 remains substantially vertical when the hitch insert 30 is connected to the primary vehicle 12 and while moving between the up and down positions. This provides a compact design allowing the support drive unit 32 and movable lift support assembly 34 to remain on the primary vehicle 12 even when not towing a secondary vehicle 16.

The lift support assembly 34 includes a sliding support post 46 extending parallel to the drive support unit 32 for moving between the up and down positions. The lift support assembly 34 includes a locking clamp 48 fixedly connected between the sliding support post 46 and the second shaft 44 of the drive support unit 32 so that the sliding support post 46 moves with the second shaft 44. The outer or second shaft 44 may include a circular flange 50 to further secure the locking clamp 48 to ensure a fixed and solid mechanical connection between the locking clamp 48, sliding support post 46 and second shaft 44. Also included is a u-shaped stop bracket 52 welded or otherwise fixedly connected to the outer shaft to provide a stop for limiting the upward motion of the sliding support post. The sliding support post 46 includes a lower end 54 and an upper end 56. The upper end 56 is connected to the locking clamp 48. The upper end 56 includes a clamp hole 58 therethrough and the locking clamp 48 includes a connector hole 60 wherein a bolt 62 can be secured through aligned clamp hole 58 and connector hole 60 to secure the locking clamp 48 to the sliding support post 46.

The hitch support arm 28 has a hitch end 64 and a mount end 66. The hitch end 64 forms the hitch insert 30 for coupling to and support within the trailer hitch receiver 14 of the primary vehicle 12. The mount end 66 includes mount receiver 68 for fixedly receiving and connecting to the drive support unit 32, and more particularly the first shaft 42 thereof. A positioning collar 70 is fixedly connected to the mount receiver 68 for receiving the sliding support post 46 therethrough such that the support post 46 slides within the positioning collar 70 while maintaining the support post 46 parallel with the drive support unit 32. The positioning collar 70 has a locking hole 72 therethrough. The lower end 54 of the support post 46 includes a limit hole 74 therethrough, such that when the lift support assembly 34 is moved to the up position, the limit hole 74 aligns with the locking hole 72 and a locking pin 76 is pushed through the holes 72, 74 to physically support the lift support assembly 34 in the up position. This provides mechanical support by the locking pin 76 allowing the drive system 38 to release its gearing while the secondary vehicle 16 raised and towed, reducing the load on the drive system 38.

The support post 46 includes an extending pivot support member 78 fixedly attached to the lower end 54 of the support post 46. The extending pivot support member 78 includes a support aperture or hole 80 therethrough to receive a bolt 82, acting as a pivot, therethrough, as subsequently described. The pivot support member 78 may be welded or otherwise permanently attached to the support post 46.

The lift support assembly 34 includes a pivot arm 84 secured to the sliding support post 46, and more particularly, the pivot arm 84 is connected to the extending pivot support member 78. The pivot arm 84 pivots between a tow position and a lowered position. The pivot arm 84 has a pintle end 86 and a locking end 88. The pintle end 86 of the pivot arm 84 moves up in the tow position and storage position, and pivots down in the lowered position and secondary vehicle coupling and de-coupling position. FIG. 1 shows the pivot arm 84 in the tow position which is the same position as storage during non-use, but remaining attached to the primary vehicle 12. FIG. 2 shows the pivot arm 84 in the lowered position, wherein the secondary vehicle 16 may be attached or detached. The pivot arm 84 is substantially horizontal in the lowered position and at an approximately 45-degree angle from horizontal in the tow or storage position.

The pivot arm 84 includes a pivot hole 90 therethrough centrally located between the pintle end 86 and locking end 88. The pivot hole 90 is shown near the middle of the pivot arm 84. However, other positions are possible which may depend on leverage and/or locking needed. The pivot hole 90 is secured to the support hole 80 of the pivot support member 78 by the connector or bolt 82 so that the pivot arm 84 pivots with respect to the extending pivot support member 78 and therefore the support post 46. The pivot arm 84 includes a bent elbow 94 extending from the locking end 88 at an angle from the pivot arm 84 to engage the hitch support arm 28 in the up position and to force the pivot arm 84 to pivot to the tow position by raising the pintle end 86. This pivoting allows the tow system 10 to raise the secondary vehicle 16 higher than the travel of the drive system 38 and further elevates the pintle end 86.

The pintle end 86 of the pivot arm 84 includes a mounting block 96 secured thereto. The mounting block 96 is secured to the pivot arm 84 at an angle, shown as approximately 45 degrees, so that the mounting block 96 is substantially vertical in the tow position. The mounting block 96 may be fixedly connected to the pivot arm 84 by suitable fasteners or other permanent means, such as welding. A pintle hitch or hook 98, as commonly known in the art, is fixedly secured to the mounting block 96 by suitable connectors 98 so that the pintle hitch 98 is raised with the pivot arm 84.

The vehicle coupler 36 includes a frame mount 102 securely attached to the undercarriage frame 22 of the secondary vehicle 16. The frame mount 102 includes a coupling arm 104 extending along the undercarriage 22 from the secondary vehicle 16. The coupling arm 104 typically extends for a distance less than the front edge 18 of the secondary vehicle 16 so as not to extend beyond the vehicle 16 but allow easy access by a user thereof. The vehicle coupler 36 includes a removable tow bar 106 for removable connection between the pintle 98 and to the coupling arm 104 so that the secondary vehicle 16 can be disconnected from the primary vehicle 12 when not being towed by removal of the tow bar 106. The removable tow bar 106 includes a lunette ring 108 for connection to the pintle 98, and a locking receiver end 110 with a lock hole 112. The frame mount 102 includes a cross bar or plate 114 for directly connecting to the undercarriage 22 of the secondary vehicle 16 and the coupling arm 104 is connected and extends out perpendicular to the cross bar 114. The cross bar or plate 114 would be bolted to the undercarriage of the secondary vehicle 16, usually by a mechanic. The coupling arm 104 has a mounting hole 116 therethrough, the coupling arm 104 being received within the locking receiver end 110 of the tow bar 106 so that the lock hole 112 aligns with the mounting hole 116 to receive a removeable connector pin 118 therethrough.

In operation, a user would initially have the frame mount 102 fixedly attached and positioned on their secondary or passenger vehicle 16. The frame mount 102 would remain permanently attached to the secondary vehicle 16 at all times or during the traveling season since it will take access to under the secondary vehicle 16. The hitch support arm 28 is mounted on to the hitch receiver 14 of the motor home or other primary towing vehicle 12. The locking pin 76 can be removed and the drive support unit 32 operated to draw the second shaft 44 down and further over the first, inner shaft 42 which slides the support shaft 42 downward to lower the lift support assembly 34 which causes the pivot arm 84 to move to a horizontal position near ground level. The user can connect the tow bar 106 to the coupling arm 104 of the frame mount 102, then slightly raise the lunette ring 108 for engagement with the pintle 98. The pintle 98 can then be locked. Thereafter, the drive system 38 is operated to raise the support post 46 causing the elbow 94 to engage the hitch support arm 28 to pivot the pivot arm 84 to a further raised, tow position such that the locking hole 72 and limit hole 74 align so that the locking pin 76 can be placed therein.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A tow system for connection to a primary vehicle having a trailer hitch receiver and for towing a secondary vehicle having first and second vehicle ends and an undercarriage frame therebetween, said tow system comprising:
a hitch insert removably securable to the trailer hitch receiver;
a drive support unit connected to said hitch insert, said drive support unit including a fixed vertical shaft connected to said hitch insert;
a movable lift support assembly movably connected to said drive support unit for moving between an up position and a down position with respect to said hitch insert, said movable lift support assembly including a sliding support post moving between the up position and the down position substantially parallel to said fixed vertical shaft between the up and down positions; and
a vehicle coupler for selectively connecting and disconnecting said movable lift support assembly to the secondary vehicle while in the down position, and said vehicle coupler raising the first end of the secondary vehicle when connected to said movable lift support assembly as the movable lift support assembly moves to the up position for towing the secondary vehicle behind the primary vehicle.

2. A tow system as set forth in claim 1 wherein said drive support unit includes an electro-mechanical drive system for moving said movable lift support assembly between the up and down positions.

3. A tow system as set forth in claim 1 wherein the drive support unit includes an outer shaft sliding with respect to said fixed vertical shaft, and the drive support unit is attached between said fixed vertical shaft and said outer shaft to extend and retract said fixed vertical shaft with respect to said outer shaft causing said tow system to move between the up and down positions.

4. A tow system as set forth in claim 3 wherein said movable lift support assembly includes a locking clamp fixedly connected between said sliding support post and said outer shaft of said drive support unit so that said sliding support post moves with said outer shaft and said sliding support post remains spaced from and parallel to said outer shaft.

5. A tow system as set forth in claim 4 wherein said movable lift support assembly includes a pivot arm having a pintle end and a locking end and pivotally secured to said sliding support post for pivoting between a tow position and lowered position when said sliding support post moves between the up position and down positions, respectively.

6. A tow system as set forth in claim 5 wherein said sliding support post includes a lower end and an upper end, said upper end connected to said locking clamp and said lower end connected to said pintle end of said pivot arm.

7. A tow system as set forth in claim 6 wherein the tow system includes a hitch support arm, said hitch support arm having a first end providing said hitch insert and a second end including a mounting base fixedly connected to said drive support unit, said mounting base includes a positioning collar for receiving said sliding support post therethrough, said sliding support post sliding within said positioning collar parallel with said drive support unit.

8. A tow system as set forth in claim 7 wherein said positioning collar includes a locking hole therethrough and said sliding support post includes a limit hole therethrough such that said locking hole and said limit hole align in the up position to receive a locking pin to mechanically support the tow system and the first end of the secondary vehicle in the up position.

9. A tow system as set forth in claim 8 wherein said sliding support post includes an extending pivot support member fixedly attached to said lower end of said sliding support post, said extending pivot support member including a support hole therethrough, said pivot arm including a pivot hole located longitudinally between said pintle and locking ends, said pivot hole being secured to said support hole by a connector so that said pivot arm pivots with respect to said extending pivot support member, and said pivot arm includes an elbow at said locking end to engage and pivot said pivot arm to the tow position as said hitch support arm moves in the up position.

10. A tow system as set forth in claim 9 wherein said vehicle coupler includes a frame mount securely attached to the undercarriage frame of the secondary vehicle, said frame mount including a coupling arm extending along the undercarriage frame of the secondary vehicle; and said vehicle coupler including a removable tow bar for removable connection between said movable lift support assembly and said coupling arm so that the first end of the secondary vehicle is raised when said tow bar is connected between said movable lift support assembly and said coupling arm and the movable lift support assembly is moved to the up position.

11. A tow system for connection to a primary vehicle having a trailer hitch receiver and for towing a secondary vehicle having first and second vehicle ends, the system comprising:
a hitch insert removably securable to the trailer hitch receiver;
a drive support unit connected to said hitch insert;
a movable lift support assembly movably connected to said drive support unit for moving between an up position and a down position with respect to said hitch insert;
a vehicle coupler for connecting and disconnecting said movable lift support assembly to the secondary vehicle, said vehicle coupler raising the first end of the secondary vehicle when connected to said movable lift support assembly as the movable lift support assembly moves to the up position for towing the secondary vehicle behind the primary vehicle;
sad vehicle coupler including a frame mount securely attached to the undercarriage frame of the secondary vehicle, said frame mount including a coupling arm extending along the undercarriage of the secondary vehicle toward the first vehicle end; and
sad vehicle coupler including a removable tow bar for removable connection between said movable lift support assembly and said coupling arm so that the first end of the secondary vehicle is raised when said tow bar is connected between said movable lift support assembly and said coupling arm with the movable lift support assembly is in the up position.

12. A tow system as set forth in claim 11 wherein said movable lift support assembly includes a pintle, and said removable tow bar includes a lunette ring for connection to said pintle.

13. A tow system as set forth in claim 11 wherein said removable tow bar includes a locking receiver end with a lock hole, and said frame mount includes a cross bar for connecting to the undercarriage of the secondary vehicle and said coupling bar connected perpendicular to said cross bar, said coupling bar having a mounting hole therethrough, said coupling bar being received within said locking receiver end of said tow bar so that said lock hole aligns with said mounting hole to receive a connector therethrough.

14. A tow system as set forth in claim 13 wherein said drive support unit includes an electric drive system for moving said movable lift support assembly between the up and down positions, and wherein said drive support unit remains substantially vertical when said hitch insert is connected to the primary vehicle and while moving between the up and down positions.

15. A tow system as set forth in claim 14 wherein said movable lift support assembly includes a sliding support post spaced from and parallel to said drive support unit for moving between the up and down positions.

16. A tow system as set forth in claim 15 wherein said drive support unit includes an inner shaft fixedly connected to said hitch insert and an outer shaft sliding with respect to said inner shaft, and a motor assembly attached between said inner and outer shafts to extend and retract said inner shaft with respect to said outer shaft causing said tow system to move between the up and down positions.

17. A tow system as set forth in claim 16 wherein said movable lift support assembly includes a locking clamp fixedly connected between said sliding support post and said outer shaft of said drive support unit so that said sliding support post moves with said outer shaft; and said support assembly includes a pivot arm having a pintle end and a locking end and pivotally secured to said sliding support post for pivoting between a tow position and lowered position when said sliding support post moves between the up position and down position, respectively, and said sliding support post includes a lower end and an upper end, said upper end connected to said locking clamp and said lower end connected to said pivot arm.

18. A tow system for connection to a primary vehicle having a trailer hitch receiver and for towing a secondary vehicle having first and second vehicle ends and an undercarriage frame, the system comprising:
a hitch support arm having a hitch insert for support within the trailer hitch receiver;
a drive support unit connected to said hitch insert;
a movable lift support assembly movably connected to said drive support unit for moving between an up position and down position with respect to said hitch insert;
a vehicle coupler for connecting and disconnecting the movable lift support assembly to the secondary vehicle while in the down position, and said vehicle coupler raising the first end of the secondary vehicle when connected to said movable lift support assembly as said movable lift support assembly moves to the up position for towing the secondary vehicle behind the primary vehicle; and
sad movable lift support assembly including a sliding support post having a lower end and an upper end moving between the up position and down position, and a pivot arm having a pintle end and a locking end, said pivot arm pivotally secured to said lower end and said upper end connected to said drive support unit wherein said pivot arm pivots with respect to said lower end between a lowered position when said sliding support post moves to the down position to allow connecting to the secondary vehicle and a tow position when said sliding support post moves to the up position to lift the first end of the secondary vehicle.

19. A tow system as set forth in claim 18 wherein said pivot arm includes an elbow at said locking end to engage said hitch support arm in the up position to pivot said pivot arm to the tow position.

20. A tow system as set forth in claim 19 wherein said hitch support arm has a first end providing said hitch insert and a second end including a mounting base fixedly connected to said drive support unit, said mounting base includes a positioning collar for receiving said sliding support post therethrough, said sliding support post sliding within said positioning collar parallel with said drive support unit; said drive support unit remaining vertical when connected to the primary vehicle.
